(19) United States
(12) Patent Application Publication
(10) Pub. No.: US 2004/0040293 A1
(43) Pub. Date: Mar. 4, 2004

(54) Internal combustion engine

(76) Inventors: Axel Klimmek, Schwaikheim (DE); Tilmann Seidel, Stuttgart (DE)

Correspondence Address: Walter Ottesen, Patent Attorney, P.O. Box 4026, Gaithersburg, MD, 20885-4026, US

(21) Appl. No.: 10/648,325

(22) Filed: Aug. 27, 2003

(30) Foreign Application Priority Data
Aug. 27, 2002 (DE) 102 39 116.5

(51) Int. Cl. F02B 27/02

(52) U.S. Cl. 60/314; 60/312

(57) ABSTRACT

An internal combustion engine, especially of a two-stroke engine in a portable handheld work apparatus, includes an outlet (27) for the exhaust gases which is fluidly connected with at least one inlet opening (13, 14) in an exhaust-gas muffler (1). At least one resonance pipe (6, 7) is mounted in flow direction between the outlet (27) from the engine (20) and the inlet opening (3, 5) into the exhaust-gas muffler (1) in order to obtain a good noise attenuating result and simultaneously make possible an advantageous, space-saving mounting of the engine (20).

### FIELD OF THE INVENTION

The invention relates to an internal combustion engine, especially a two-stroke engine in a portable handheld work apparatus such as a motor-driven chain saw, cutoff machine or the like.

### BACKGROUND OF THE INVENTION

international patent publication WO 01/21941 A1 discloses an internal combustion engine whose outlet opens into the attenuating space of a muffler. A closed resonance pipe is mounted between the outlet and the exhaust-gas muffler. For an effective attenuation, the resonance pipe must have a long length. This leads to an unfavorable mounting with which the available space for components can be poorly utilized.

### SUMMARY OF THE INVENTION

It is an object of the invention to provide an internal combustion engine of the kind described above which has good noise attenuation and can be advantageously integrated into available component space.

The internal combustion engine of the invention includes a two-stroke engine for a handheld portable work apparatus. The internal combustion engine includes: an outlet for discharging exhaust gases in a flow direction from the engine; an exhaust-gas muffler having an inlet opening for receiving the exhaust gases; and, at least one resonance pipe arranged in the flow direction between the outlet and the inlet opening for fluidly connecting the outlet to the inlet.

A good noise attenuation can be achieved with the arrangement of at least one resonator pipe in flow direction between the outlet from the internal combustion engine and the inlet opening into an exhaust-gas muffler. At the same time, the exhaust-gas muffler can be mounted at a location remote from the outlet. In this way, the existing component space can be well utilized. The arrangement can be flexibly adapted to the mounting conditions. The arrangement of a resonance pipe in the flow path between the internal combustion engine and the exhaust-gas muffler leads to increased power of the engine. At the same time, the quality of the exhaust gas can be improved.

In order to obtain a good attenuation of noise, it is provided that the resonance pipe opens with a diaphragm into the exhaust-gas muffler. The equivalent diameter of the diaphragm measured in millimeters is 1 to 3 times and especially 1.2 to 2.4 times the square root of the volume of the piston displacement of the internal combustion engine with the volume measured in cubic centimeters. The equivalent diameter is the diameter of a circularly-shaped diaphragm which corresponds to the actual diaphragm at the opening into the exhaust-gas muffler. The diaphragm leads to a partial back flow of exhaust gas from the resonance pipe into the combustion chamber of the engine. In this way, the exhaust-gas values are improved. In order to obtain a good adaptation of the noise attenuation, for example, in specific rpm ranges, the diameter of the diaphragm is variable. A good noise attenuation results when the equivalent diameter of the resonance pipe, measured in millimeters, is approximately 2.5 to 6 times the square root of the volume (measured in cubic centimeters) of the piston displacement of the internal combustion engine.

The equivalent diameter of the resonance pipe is approximately constant over the length of the resonance pipe. In order to achieve a good exhaust-gas noise attenuation, the length of the resonance pipe is matched to the rpm of the engine, especially to 60% to 100% of the rated rpm. To obtain good noise attenuation in a wide frequency range, it is practical to provide several resonance pipes. These resonance pipes can be matched to different frequencies. The inlet into at least one resonance pipe can be configured so as to be closeable. In the arrangement of several resonance pipes, one or several resonance pipes can be switched in. In this way, a further adaptation of the noise attenuation to the particular operating conditions is possible. Advantageously, at least one inlet opening in the exhaust-gas muffler is configured so that it can be closed. In this way, a further adaptation of the noise attenuation to the respective operating states is possible. Advantageously, at least one inlet opening into the exhaust-gas muffler is configured so that it can be closed. For this reason, with the use of several resonance pipes, one or several resonance pipes can be used as a closed resonance pipe as required. In this way, advantageous influences on the noise attenuation result. The adaptation to the particular operating states can then take place in a flexible manner.

### BRIEF DESCRIPTION OF THE DRAWINGS

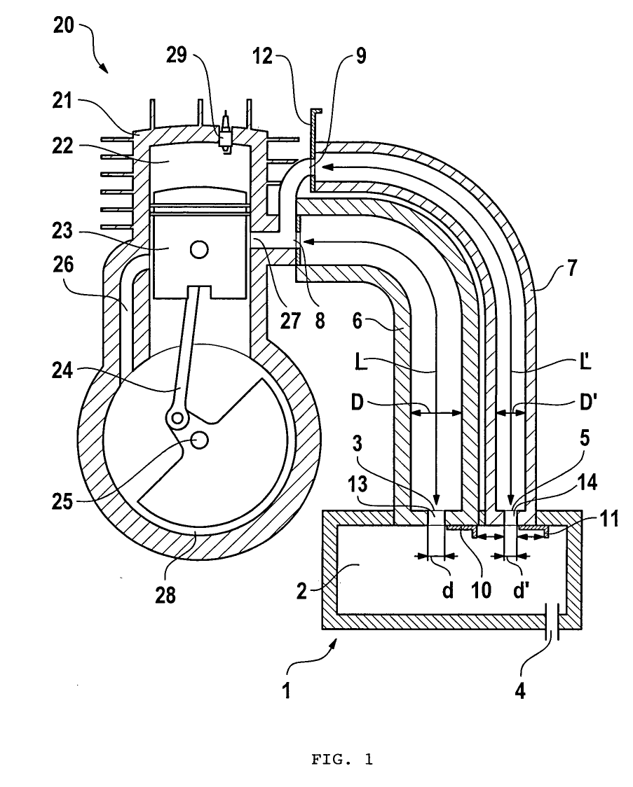

The invention will now be described with reference to the single FIGURE (FIG. 1) of the drawing which shows a schematic of an internal combustion engine on whose outlet two resonance pipes are mounted.

### DESCRIPTION OF THE PREFERRED EMBODIMENTS OF THE INVENTION

The internal combustion engine 20 is configured as a two-stroke engine and has a cylinder 21 wherein a combustion chamber 22 is formed. The combustion chamber 22 is delimited by a reciprocating piston 23 which drives a crankshaft 25 via a connecting rod 24. The crankshaft 25 is rotatably journalled in a crankcase 28. The crankcase 28 is connected via at least one transfer channel 26 to the combustion chamber 22 at pregiven positions of the piston 23.

During operation of the internal combustion engine 20, an air/fuel mixture is supplied to the crankcase 28 via an inlet (not shown). In the downward stroke of the piston 23, the mixture is compressed in the crankcase 28 and flows through the transfer channel(s) 26 into the combustion chamber 22 in the region of bottom dead center of the piston 23. In the combustion chamber 22, the mixture is compressed by the upward moving piston 23 and is ignited in the region of top dead center by the spark plug 29. In the next-following downward stroke of the piston 23, the exhaust gases flow out of the combustion chamber 22 as soon as the outlet 27 out of the combustion chamber 22 is cleared by the piston 23.

Two resonance pipes 6 and 7 are connected to the outlet 27. The first resonance pipe 6 opens with an inlet opening 3 into the attenuating space 2 of the exhaust-gas muffler 1. The second resonance pipe 7 opens with the inlet opening 5 into the attenuating space 2 of the exhaust-gas muffler 1. The exhaust gases from the attenuating space 2 of the exhaust-gas muffler 1 reach the ambient via the exit opening 4.

The resonance pipes 6 and 7 open with diaphragms 13 and 14, respectively, into the attenuating space 2. The first resonance pipe 6 has a length L as well as a diameter D. The diameter D is constant over the total length L of the resonance pipe 6. The diaphragm 13 has an equivalent diameter d. Correspondingly, the second resonance pipe 7 has a length L′ as well as a diameter D′ constant over the entire length L′. The second resonance pipe 7 opens with a diaphragm 14 into the attenuating space 2 which has an equivalent diameter d′. The equivalent diameters (d, d′) of the respective diaphragms 13 and 14 are advantageously measured in millimeters and are approximately 1 to 3 times (especially 1.2 to 2.4 times) the square root of the volume (measured in cubic centimeters) of the piston displacement of the internal combustion engine 20. Advantageous equivalent diameters (d, d′), which are measured in millimeters, result with the 1.5 to 2.1 times the square root of the volume (measured in cubic centimeters) of the piston displacement of the engine 20. The equivalent diameter (D, D′) of the resonance pipes (6, 7) advantageously is approximately 2.5 times to 6 times the square root of the volume (measured in cubic centimeters) of the piston displacement of the engine 20.

Sliders (10, 11) are mounted in the region of the diaphragms (13, 14), respectively, with which the equivalent diameters (d, d′) of the respective diaphragms 13 and 14 are varied and the diaphragms 13 and 14 can be completely closed. By closing one of the diaphragms 13 or 14, the muffler characteristics can be changed because one of the resonance pipes is then configured as a closed resonance pipe. The muffler characteristics can be varied with the reduction of the diameter (d, d′) of the diaphragms 13 and 14. In this way, an adaptation to different operating states of the engine 20 is possible. A slider 12 is mounted in the region of the inlet 9 into the second resonance pipe 7 with which the inlet 9 can be closed. Only the first resonance pipe 6 is effective when the inlet 9 is closed. The number of effective resonance pipes can be varied in this way. In lieu of sliders, other suitable means for varying the equivalent diameters and for closing the diaphragms can be provided.

In lieu of mounting two resonance pipes, the mounting of one or several resonance pipes can be advantageous. It can be advantageous to configure also the inlet in one or several resonance pipes with a variable cross section. The length(s) of the resonance pipe(s) is advantageously matched to the rpm of the engine 20, especially to 60% to 100% of the rated rpm.

It is understood that the foregoing description is that of the preferred embodiments of the invention and that various changes and modifications may be made thereto without departing from the spirit and scope of the invention as defined in the appended claims.

What is claimed is:

1. An internal combustion engine including a two-stroke engine for a handheld portable work apparatus, the internal combustion engine comprising:
an outlet for discharging exhaust gases in a flow direction from said engine;
an exhaust-gas muffler having an inlet opening for receiving said exhaust gases; and,
at least one resonance pipe arranged in said flow direction between said outlet and said inlet opening for fluidly connecting said outlet to said inlet.

2. The internal combustion engine of claim 1, wherein said resonance pipe has a diaphragm for opening into said exhaust-gas muffler.

3. The internal combustion engine of claim 2, wherein said diaphragm has an equivalent diameter (d, d′) measured in millimeters which amounts approximately 1 to 3 times the square root of the volume of the piston displacement of said engine with said volume being measured in cubic centimeters.

4. The internal combustion engine of claim 2, wherein said diaphragm has an equivalent diameter (d, d′) measured in millimeters which amounts approximately 1.2 to 2.4 times the square root of the volume of the piston displacement of said engine with said volume being measured in cubic centimeters.

5. The internal combustion engine of claim 3, wherein said equivalent diameter (d, d′) is variable.

6. The internal combustion engine of claim 4, wherein said resonance pipe has an equivalent diameter (D, D′) measured in millimeters which amounts to approximately 2.5 to 6 times the square root of the volume of the piston displacement of said engine with said volume being measured in cubic centimeters.

7. The internal combustion engine of claim 6, wherein said equivalent diameter (D, D′) of said resonance pipe is approximately constant over the length (L, L′) thereof.

8. The internal combustion engine of claim 7, wherein said length (L, L′) of said resonance pipe is matched to the engine speed (rpm) of said engine.

9. The internal combustion engine of claim 8, wherein said length (L, L′) of said resonance pipe is matched to 60% to 100% of the rated rpm of said engine speed (rpm).

10. The internal combustion engine of claim 1, wherein said resonance pipe is one of a plurality of resonance pipes.

11. The internal combustion engine of claim 10, wherein the inlet in at least one of said resonance pipes is closeable.

12. The internal combustion engine of claim 10, wherein at least one inlet opening into said exhaust-gas muffler is configured to be closeable.
